(19) United States
(12) Patent Application Publication
(10) Pub. No.: US 2017/0160410 A1
(43) Pub. Date: Jun. 8, 2017

(54) Seismic reflection data acquisition method adopting concentric circle equal offset

(71) Applicant: Changjiang Geophysical Exploration & Testing (Wuhan) Co., Ltd., Wuhan (CN)

(72) Inventors: Jianqing Zhang, Wuhan (CN); Peng Li, Wuhan (CN); Shengmin Ma, Wuhan (CN); Liangqing Ding, Wuhan (CN); Fangwen Liu, Wuhan (CN); Ernan Lu, Wuhan (CN); Jianshe Cheng, Wuhan (CN)

(73) Assignee: Changjiang Geophysical Exploration & Testing (Wuhan) Co., Ltd.

(21) Appl. No.: 15/398,738

(22) Filed: Jan. 5, 2017

(30) Foreign Application Priority Data
Jan. 18, 2016 (CN) 201610032385.9

(51) Int. Cl. G01V 1/00; G01V 1/24

(52) U.S. Cl. CPC G01V 1/003; G01V 1/242

(57) ABSTRACT

A seismic reflection data acquisition method adopts concentric circle equal offset, which is in the engineering geophysical exploration technology field. Specifically the receivers are placed in a way of concentric circle. Choose a compact point on the rock on the tunnel surface; takes the hypocenter as the center and set three concentric survey circles; stimulates seismic waves at the center and receives the reflection wave from the place ahead of the tunnel face by the receivers. A 3D graphics is created based on the positions of the receivers on the tunnel face, by which a 3D geotectonic face is able to be observed clearly through corresponding analysis processing method to receive the information of structures and defective geological bodies ahead.

### CROSS REFERENCE OF RELATED APPLICATION

This application claims priority under 35 U.S.C. 119(a-d) to CN 201610032385.9, filed Jan. 18, 2016.

### BACKGROUND OF THE PRESENT INVENTION

Field of Invention

The present invention relates to a seismic reflection data acquisition method adopting concentric circle equal offset, and more particularly to engineering geophysical exploration field. The present invention is geophysical prospecting applied in tunnel data acquisition, which is a vertical reflection method. Specifically the receivers are placed in a way of concentric circle. Stimulates seismic waves at the center and receives the reflection wave from the place ahead of the tunnel face by the receivers. Receive the information of structures and defective geological bodies ahead through corresponding analysis processing method.

Description of Related Arts

The present invention is one of the tunnel geological prediction vertical reflection methods. The method is carried out with minimum offset (the distance between the shot and receiver is approaching zero), which is also called minimum offset reflection method. The main advantage of the present invention is that the waveform of the seismic reflection signal is simple without other converted waves. When the longitudinal wave enters, the recorded waveform is just reflected longitudinal wave. So the data processing is easy. The present invention is for narrow fields with steep relief, which has special requirements for hypocenter triggering and receiving sensors. The source must occupy the features of high frequency, high power, short time aftershock and good repetition. The receivers occupy high sensitivity, low noise, wide band and large dynamic range.

Conventional vertical reflection method adopts a geometry of placing the receiver horizontally or vertically and collecting data from the observation points in turn. The conventional data acquisition method has the below disadvantages.

1. Low data acquisition efficiency. While collecting the data on site from the observation points in turn, the receivers need to be fixed on the tunnel face by the couplant repeatedly. Besides the vertical line is affected by work at height, which further compromises the data acquisition efficiency.

2. The stamping energy is uneven. It is impossible for every stamping on the observation point has exactly same energy. During data processing the signal amplitude among different channels varies greatly.

3. Only two-dimension information is able to be received. The horizontal or vertical line is just able to receive the profile information ahead.

### SUMMARY OF THE PRESENT INVENTION

An object of the present invention is to overcome the disadvantages of the conventional tunnel vertical reflection data acquisition method and provide a data acquisition method which is able to rapidly receive three-dimension geotectonic information with evenly adjustable signal energy. In order to fulfill the object the technical solution is as below.

A seismic reflection data acquisition method adopts concentric circle equal offset, comprising the following steps:

a. selecting a compact point on a rock on a tunnel face as a hypocenter; setting three concentric survey circles with center at the hypocenter, which are a first concentric survey circle, a second concentric survey circle and a third concentric survey circle respectively, wherein radiuses of the three concentric survey circles are in proportion 1:2:3; the third concentric survey circle covers a largest area on the tunnel face of the three concentric survey circles; drawing eight sprays from a center of the concentric survey circle within the tunnel face, wherein an included angle between every two neighboring sprays is 45°; the eight sprays and the three concentric survey circles have 24 crossover points; placing 24 receivers on the crossover points respectively, wherein the receivers is fully coupling with the tunnel face;

b. connecting the receivers to a 24-channel engineering seismograph by seismic exploration cables respectively;

c. while collecting the data, taking electrical discharges or stampings as a seismic source at the hypocenter to stimulate seismic waves; wherein the 24 receivers receive seismic reflection waves from a place ahead of the tunnel face and transmit signals to the 24-channel engineering seismograph; the seismic source stimulates for many times and signal samplings are vertically superposed, wherein the minimum times of stimulation is three at an interval of at least 5 seconds.

If the electrical discharges are adopted as the seismic source, a round hole with a depth of 1 m needs to be drilled at a center of the concentric survey circle; an axis of the hole is vertical to the tunnel face wall and tilts downward by 10°.

A natural frequency difference between any two of the receivers is less than 10%; a sensitivity difference is less than 10%; a phase difference is less than 1 ms; seismic traces meets a requirement of consistency, which is that a phase difference between any two seismic traces is less than 1.5ms and an amplitude difference is less than 15%.

A radius of the smallest concentric survey circle is within a range of 0.5-1.5 m.

The observation system which adopts the above technical solution has the below advantages.

1. High data acquisition efficiency. While data acquisition on site the receivers are coupled onto the tunnel face and connected with the seismic exploration cable. With one signal triggering information is able to be collected from all the receivers.

2. The exploration covers a wide range. The concentric survey circles cover most part of the tunnel face and the exploration range is wider compared to the horizontal and vertical line.

3. A three-dimension model is able to be created with the waveform received by every receiver according to the positions of the receivers, by which the structures is able to be observed.

4. The signal amplitude collected by every concentric survey circle is relatively uniform. The signal amplitude collected by different concentric survey circle is able to be equalized through a certain formula.

### BRIEF DESCRIPTION OF THE DRAWINGS

FIG. 1 is a perspective view of concentric circle equal offset observation system of vertical reflection method;

FIG. 2 is a record of seismic waves of a tunnel in embodiment 1 adopting the present observation system;

FIG. 3 is a three-dimension resultant plot of a tunnel in embodiment 1 adopting the present observation system.

### DETAILED DESCRIPTION OF THE PREFERRED EMBODIMENT

The present invention is one of the tunnel geological prediction vertical reflection methods. The method is carried out with minimum offset (the distance between the shot and receiver is approaching zero), which is also called minimum offset reflection method. The main advantage of the present invention is that the waveform of the seismic reflection signal is simple without other converted waves. When the longitudinal wave enters, the recorded waveform is just reflected longitudinal wave. So the data processing is easy. The present invention is for narrow fields with steep relief, which has special requirements for hypocenter triggering and receiving sensor. The hypocenter must occupy the features of high frequency, high power, short time aftershock and good repetition. The receivers occupy high sensitivity, low noise, wide band and large dynamic range.

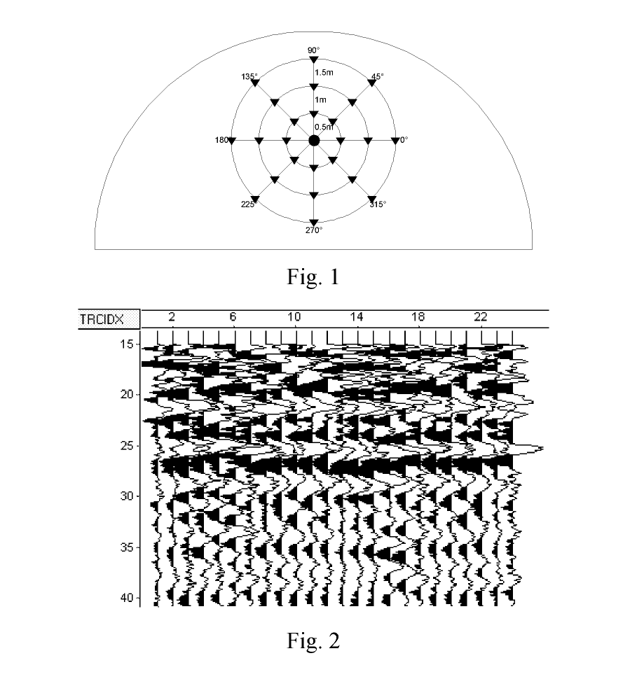

Referring to FIG. 1 to FIG. 3 of the drawings, according to a preferred embodiment of the present invention is illustrated, wherein a seismic reflection data acquisition method adopting concentric circle equal offset, comprising the following steps:

a. selecting a compact point on a rock on a tunnel face as a hypocenter; setting three concentric survey circles with center at the hypocenter, which are a first concentric survey circle , a second concentric survey circle and a third concentric survey circle respectively, wherein radiuses of the three concentric survey circles are in proportion 1:2:3; the third concentric survey circle covers a largest area on the tunnel face of the three concentric survey circles; drawing eight sprays from a center of the concentric survey circle within the tunnel face, wherein an included angle between every two neighboring sprays is 45°; the eight sprays and the three concentric survey circles have 24 crossover points; placing 24 receivers on the crossover points respectively, wherein the receivers is fully coupling with the tunnel face;

b. connecting the receivers to a 24-channel engineering seismograph by seismic exploration cables respectively;

c. while collecting the data, taking electrical discharges or stampings as a seismic source at the hypocenter to stimulate seismic waves; wherein the 24 receivers receive seismic reflection waves from a place ahead of the tunnel face and transmit signals to the 24-channel engineering seismograph; in order to improve the signal-noise ratio of seismic records, the seismic source stimulates for many times and signal samplings are superposed, wherein the minimum times of stimulation is three at an interval of at least 5 seconds.

If the electrical discharges are adopted as the seismic source, a round hole with a depth of 1 m is drilled at a center of the concentric survey circle; an axis of the hole is vertical to the tunnel face wall and tilts downward by 10°.

Before carrying out the work, the instruments need to be checked and a record needs to be submitted. A difference in the natural frequency between any two of the receivers is less than 10%; a difference in the sensitivity is less than 10%; the phase difference is less than 1 ms; The receivers meets a requirement of consistency, which is that a phase difference between any two seismic traces is less than 1.5 ms and a difference in the amplitude is less than 15%. While testing the consistency of the receivers, the placement conditions of the receivers should be consistent. The placement range of all the receivers is small compared to the distance to the hypocenter. If the receiver adopts needle socket, a hole needs to be drilled at the detecting point. The diameter of the hole is bigger than the minimum diameter of the needle socket and smaller than the maximum diameter of the needle socket. The receivers are inserted into the detecting points and pressed tight. If a triangle iron socket is adopted, the receivers are coupled into the tunnel face by couplant. In order to keep the signal consistent the placement of the receiver should be parallel to the axis of the tunnel.

A radius of the first concentric survey circle which is the minimum offset is within a range of 0.5-1.5 m.

### Embodiment 1

A certain hydropower tunnel project in Yunnan province, China adopts the vertical reflection method of concentric circle equal offset observation system to explore. The radius of the tunnel is about 9 m. The left below corner of the tunnel face is set as (0.0) and coordinate (4.4, 3.5) is set as the triggering point. The electrical discharge is adopted as the seismic source. The depth of the dill hole of the electrical discharge seismic source is 1 m. The axis of the hole is vertical to the tunnel face wall and tilts downward by 10°. The hole is at the center as illustrated in FIG. 1. The radius of the first concentric survey circle is 0.5 m, the radius of the second concentric survey circle is 1 m and the radius of the third concentric survey circle is 1.5 m. Eight sprays are drawn from the center of the concentric survey circles within the tunnel face, wherein an included angle between every two neighboring sprays is 45°; the eight sprays and the three concentric survey circles have 24 crossover points; 24 receivers are placed on the crossover points respectively, wherein the receivers is fully coupling with the tunnel face by instant plaster. The placement of the receivers is illustrated in FIG. 1. 24-channel 100 Hz receivers are adopted.

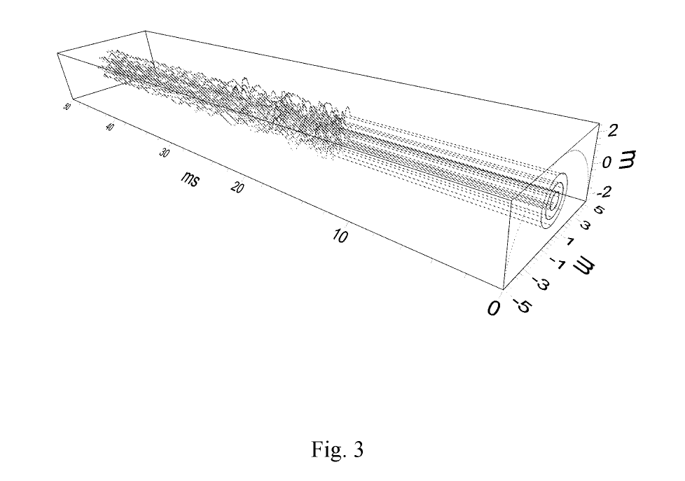

The receivers are connected to a 24-channel engineering seismograph through seismic exploration cables. Before carrying out the work, the instruments need to be checked and a record needs to be submitted. A difference in the natural frequency between any two of the receivers is less than 9%; a difference in the sensitivity is less than 8%; a phase difference is less than 1 ms; the receivers meets a requirement of consistency, which is that a phase difference between any two seismic traces is less than 1.3 ms and a difference in the amplitude is less than 12%. While testing the consistency of the receivers, the placement conditions of the receivers are consistent. The seismic waves are triggered by the electrical discharge. The signal sampling vertical superposed for 3 times and the interval between two triggering is 30 s. The signal collected is illustrated in FIG. 2. A 3-dimension graphics is created based on the position of the receivers on the tunnel face as illustrated in FIG. 3. The 3-dimension structures is able to be clearly observed. The information of the structures or the defective geological bodies is received through corresponding analysis processing method.

### Embodiment 2

A certain hydropower right bank abutment groove project in Yunnan province, China adopts the vertical reflection method of concentric circle equal offset observation system to explore. The radius of the tunnel face is about 11 m. The left below corner of the tunnel face is set as (0.0) and coordinate (5.3, 3.6) is set as the triggering point. The stamping is adopted as the seismic source. The radius of the first concentric survey circle is 0.6 m, the radius of the second concentric survey circle is 1.2 m and the radius of the third concentric survey circle is 1.8 m. Eight sprays are drawn from the center of the concentric survey circles within the tunnel face, wherein an included angle between every two neighboring sprays is 45°; the eight sprays and the three concentric survey circles have 24 crossover points; 24 receivers are placed on the crossover points respectively, wherein the receivers adopt triangle socket and are fully coupling with the tunnel face by instant plaster. The placement of the receivers is illustrated in FIG. 1. 24-channel 30 Hz receivers are adopted. The receivers are connected to a 24-channel engineering seismograph through seismic exploration cables. Before carrying out the work, the instruments need to be checked and a record needs to be submitted. A difference in the natural frequency between any two of the receivers is less than 10%; a difference in the sensitivity is less than 9%; a phase difference is less than 1 ms; the receivers meets a requirement of consistency, which is that a phase difference between any two seismic traces is less than 1.4 ms and a difference in the amplitude is less than 15%. While testing the consistency of the receivers, the placement conditions of the receivers are consistent. The seismic waves are triggered by the stamping. The signal sampling vertical superposed for 5 times and the interval between two triggering is 5 s. A 3-dimension graphics is created based on the position of the receivers on the tunnel face. The 3-dimension structures is able to be clearly observed. The information of the structures or the defective geological bodies is received through corresponding analysis processing method.

### Embodiment 3

A certain hydropower underground powerhouse project in Yunnan province, China adopts the vertical reflection method of concentric circle equal offset observation system to explore. The radius of the tunnel is about 11 m. The left below corner of the tunnel face is set as (0.0) and coordinate (6.4, 5.3) is set as the triggering point. The electrical discharge is adopted as the seismic source. The depth of the dill hole of the electrical discharge seismic source is 1 m. The axis of the hole is vertical to the tunnel face wall and tilts downward by 10°. The radius of the first concentric survey circle is 1.5 m, the radius of the second concentric survey circle is 3 m and the radius of the third concentric survey circle is 4.5 m. Eight sprays are drawn from the center of the concentric survey circles within the tunnel face, wherein an included angle between every two neighboring sprays is 45°; the eight sprays and the three concentric survey circles have 24 crossover points; 24 receivers are placed on the crossover points respectively. The receivers adopt needle socket. Holes are drilled at the detecting points. The diameter of the hole is bigger than the minimum diameter of the needle socket and smaller than the maximum diameter of the needle socket. The receivers are inserted into detecting points and pressed tight. 24-channel 30 Hz receivers are adopted. The receivers are connected to a 24-channel engineering seismograph through seismic exploration cables. Before carrying out the work, the instruments need to be checked and a record needs to be submitted. A difference in the natural frequency between any two of the receivers is less than 8%; a difference in the sensitivity is less than 10%; a phase difference is less than 1 ms; the receivers meets a requirement of consistency, which is that a phase difference between any two seismic traces is less than 1.5 ms and a difference in the amplitude is less than 13%. While testing the consistency of the receivers, the placement conditions of the receivers are consistent. The seismic waves are triggered by the electrical discharge. The signal sampling vertical superposed for 3 times and the interval between two triggering is 30 s. A 3-dimension graphics is created based on the position of the receivers on the tunnel face. The 3-dimension structures is able to be clearly observed. The information of the structures or the defective geological bodies is received through corresponding analysis processing method.

What is claimed is:

1. A seismic reflection data acquisition method adopting concentric circle equal offset, comprising following steps of:
a. selecting a compact point on a rock on a tunnel face as a hypocenter;
setting three concentric survey circles with a center at the hypocenter, which are a first concentric survey circle, a second concentric survey circle and a third concentric survey circle respectively, wherein radiuses of the three concentric survey circles are in proportion 1:2:3; the third concentric survey circle covers a largest area on the tunnel face of the three concentric survey circles; drawing eight sprays from the center of the concentric survey circles within the tunnel face, wherein an included angle between every two neighboring sprays is 45°; the eight sprays and the three concentric survey circles have 24 crossover points; placing 24 receivers on the crossover points respectively, wherein the receivers are fully coupling with the tunnel face;
b. connecting the receivers to a 24-channel engineering seismograph by seismic exploration cables respectively; and
c. while collecting data, taking electrical discharges or stampings as a seismic source at the hypocenter to stimulate seismic waves;
wherein the 24 receivers receive seismic reflection waves from a place ahead of the tunnel face and transmit signals to the 24-channel engineering seismograph; the seismic source multiply stimulates and signal samplings are superposed, wherein a minimum times of stimulation is three with an interval of at least 5 seconds.

2. The seismic reflection data acquisition method adopting concentric circle equal offset, as recited in claim 1, wherein if the electrical discharges are adopted as the seismic source, a round hole with a depth of 1 m is drilled at the center of the concentric survey circles; an axis of the hole is vertical to a tunnel face wall and tilts downward by 10°.

3. The seismic reflection data acquisition method adopting concentric circle equal offset, as recited in claim 1, wherein a natural frequency difference between any two of the receivers is less than 10%; a sensitivity difference is less than 10%; a phase difference is less than 1 ms; seismic traces meet a requirement of consistency, which is that a phase difference between any two seismic traces is less than 1.5ms and an amplitude difference is less than 15%.

4. The seismic reflection data acquisition method adopting concentric circle equal offset, as recited in claim 1, wherein a radius of the first concentric survey circle is within a range of 0.5-1.5 m.
